(19) United States
(12) Patent Application Publication
(10) Pub. No.: US 2026/0359408 A1
(43) Pub. Date: Nov. 12, 2026

(54) SYSTEM, TERMINAL, CONTROL METHOD OF TERMINAL, AND STORAGE MEDIUM

(71) Applicant: NEC Corporation, Tokyo (JP)

(72) Inventors: Yoshihisa SHINGU, Tokyo (JP); Tomohide OTA, Tokyo (JP); Issei YANAGISAWA, Tokyo (JP); Daisuke SHIBUICHI, Tokyo (JP)

(73) Assignee: NEC Corporation, Tokyo (JP)

(21) Appl. No.: 19/133,370

(22) PCT Filed: Dec. 7, 2022
(86) PCT No.: PCT/JP2022/045180

§ 371 Date: May 28, 2025

(51) Int. Cl. G06F 21/32

(52) U.S. Cl. CPC G06F 21/32

(57) ABSTRACT

To provide a terminal which realizes management of authentication history and the like at a service provider selected by a user. The terminal includes a receiving means and an authentication history control means. The receiving means receives, from a service server of a service provider selected by a user from among a plurality of service providers and having succeeded in biometric authentication of the user, an authentication success notification. The authentication history control means performs control related to a history of successful biometric authentication by the service provider, in accordance with reception of the authentication success notification.

### TECHNICAL FIELD

The present invention relates to a terminal, a system, a control method of a terminal, and a storage medium.

### BACKGROUND ART

There exists a technology related to biometric authentication.

For example, Patent Literature 1 describes providing a server apparatus that improves convenience in an authentication system including a plurality of authentication terminals. The server apparatus of Patent Literature 1 includes an acquisition unit and an authentication unit. The acquisition unit acquires an authentication rule including a condition for determining authentication success. The authentication unit performs first biometric authentication in response to a first authentication request transmitted from a first terminal, and performs second biometric authentication using the authentication rule in response to a second authentication request transmitted from a second terminal.

Patent Literature 2 describes enabling a plurality of service providers to use a biometric authentication terminal while minimizing the time each user occupies the authentication terminal. The authentication apparatus of Patent Literature 2 includes an authentication table, a reception means, an authentication means, and a notification means. The authentication table manages identification information of each user and personal information including contact information of a user terminal owned by the user in association with each other. The reception means receives user identification information and authentication information from a user. The authentication means compares the authentication information input by the user with reference authentication information serving as a basis for authentication, and performs personal authentication based on a result of the comparison. The notification means refers to the authentication table and notifies a user terminal corresponding to the user of the result of the personal authentication.

### CITATION LIST

### Patent Literature

[PTL 1] International Publication WO2022/176042

[PTL 2] Japanese Unexamined Patent Application Publication No. 2006-146456

### SUMMARY OF INVENTION

### Technical Problem

In recent years, various services using biometric authentication have begun to be offered. In this context, from the viewpoint of personal information protection and privacy protection, there is a demand for users themselves to manage authentication information, authentication results, and the like used for biometric authentication. Specifically, there is a demand for users to select a service provider that receives biometric authentication from among a plurality of service providers, and to manage and check authentication history and the like at the selected service provider.

This demand cannot be realized even if the technology disclosed in Patent Document 1 or Patent Document 2 is applied. Patent Literature 1 and Patent Literature 2 do not disclose an authentication system in which a user selects a service provider from among a plurality of service providers.

It is a main object of the present invention to provide a terminal, a system, a control method of a terminal, and a storage medium, which contribute to realizing management of authentication history and the like at a service provider selected by a user.

### Solution to Problem

According to a first aspect of the present invention, there is provided a terminal, including: a receiving means that receives, from a service server of a service provider selected by a user from among a plurality of service providers and having succeeded in biometric authentication of the user, an authentication success notification; and an authentication history control means that performs control related to a history of successful biometric authentication by the service provider, in accordance with reception of the authentication success notification.

According to a second aspect of the present invention, there is provided a system, including: a service server of a service provider selected by a user from among a plurality of service providers and having succeeded in biometric authentication of the user; and a terminal owned by the user, wherein the terminal, including: a receiving means that receives an authentication success notification from the service server; and an authentication history control means that performs control related to a history of successful biometric authentication by the service provider, in accordance with reception of the authentication success notification.

According to a third aspect of the present invention, there is provided a control method of a terminal, the control method comprising: receiving, from a service server of a service provider selected by a user from among a plurality of service providers and having succeeded in biometric authentication of the user, an authentication success notification; and performing control related to a history of successful biometric authentication by the service provider, in accordance with reception of the authentication success notification.

According to a fourth aspect of the present invention, there is provided a computer-readable storage medium storing a program causing a computer mounted on a terminal to perform processing for: receiving, from a service server of a service provider selected by a user from among a plurality of service providers and having succeeded in biometric authentication of the user, an authentication success notification; and performing control related to a history of successful biometric authentication by the service provider, in accordance with reception of the authentication success notification.

### Advantageous Effects of Invention

According to the individual aspects of the present invention, there is provided a terminal, a system, a control method of a terminal, and a storage medium, which contribute to realizing management of authentication history and the like at a service provider selected by a user. The advantageous effect of the present invention is not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a flowchart illustrating an example of an operation of an example embodiment.

FIG. 3 is a diagram illustrating an example of a schematic configuration of an authentication system according to a first example embodiment.

FIG. 4 is a diagram illustrating an operation of the authentication system according to the first example embodiment.

FIG. 5 is a diagram illustrating the operation of the authentication system according to the first example embodiment.

FIG. 6 is a diagram illustrating the operation of the authentication system according to the first example embodiment.

FIG. 7 is a diagram illustrating the operation of the authentication system according to the first example embodiment.

FIG. 8 is a diagram illustrating an example of a processing configuration of a control server according to the first example embodiment.

FIG. 9 is a diagram illustrating an example of an account management database according to the first example embodiment.

FIG. 10 is a diagram illustrating an example of a display of a terminal according to the first example embodiment.

FIG. 11 is a diagram illustrating an example of a processing configuration of a service server according to the first example embodiment.

FIG. 12 is a diagram illustrating an example of a user management database according to the first example embodiment.

FIG. 13 is a flowchart illustrating an example of an operation of an authentication unit according to the first example embodiment.

FIG. 14 is a diagram illustrating an example of a processing configuration of an authentication terminal according to the first example embodiment.

FIG. 15 is a diagram illustrating an example of a processing configuration of the terminal according to the first example embodiment.

FIG. 16 is a diagram illustrating an example of the display of the terminal according to the first example embodiment.

FIG. 17 is a diagram illustrating an example of an authentication history management database according to the first example embodiment.

FIG. 18 is a diagram illustrating an example of the display of the terminal according to the first example embodiment.

FIG. 19 is a diagram illustrating an example of the display of the terminal according to the first example embodiment.

FIG. 20 is a diagram illustrating an example of the display of the terminal according to the first example embodiment.

FIG. 21 is a diagram illustrating an example of the operation of the authentication system according to the first example embodiment.

FIG. 22 is a diagram illustrating an example of a hardware configuration of a control server in the present application disclosed.

FIG. 23 is a diagram illustrating an example of a display of a terminal according to a variation of the present application disclosed.

FIG. 24 is a diagram illustrating an example of the display of the terminal according to the variation in the present application disclosed.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

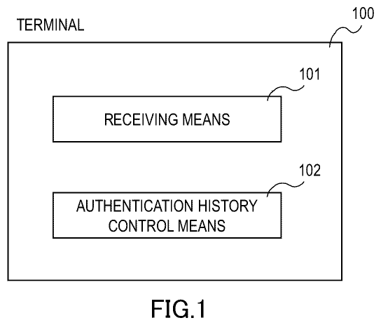

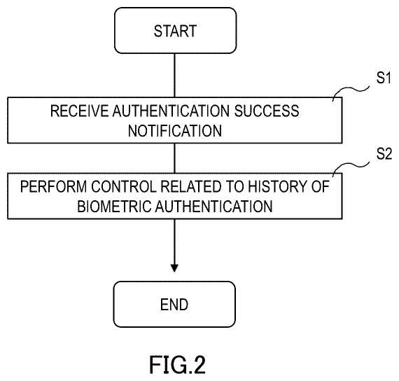

A terminal 100 according to an example embodiment includes a receiving means 101 and an authentication history control means 102 (see FIG. 1). The receiving means 101 receives, from a service server of a service provider selected by a user from among a plurality of service providers and having succeeded in biometric authentication of the user, an authentication success notification (step S1 in FIG. 2). The authentication history control means 102 performs control related to a history of successful biometric authentication by the service provider, in accordance with reception of the authentication success notification (step S2).

The user selects, from among a plurality of service providers, a service provider from which the user desires to receive a service. In accordance with the selection, an original source of authentication information used for biometric authentication is provided to the selected service provider. In a case where the service server of the service provider succeeds in authentication of the user by using the authentication information, the service server transmits to the terminal 100 an authentication success notification that notifies the fact and details of the authentication success. The terminal 100 performs control related to biometric authentication history in accordance with reception of the authentication success notification. For example, the terminal 100 enables the user to view authentication history. In this manner, the terminal 100 realizes management of authentication history and the like at the service provider selected by the user from among the plurality of service providers. By checking authentication history and the like, the user can discover unauthorized biometric authentication that they do not recognize.

Hereinafter, specific example embodiments will be described in more detail with reference to drawings.

### First Example Embodiment

A first example embodiment will be described in more detail with reference to drawings.

### System Configuration

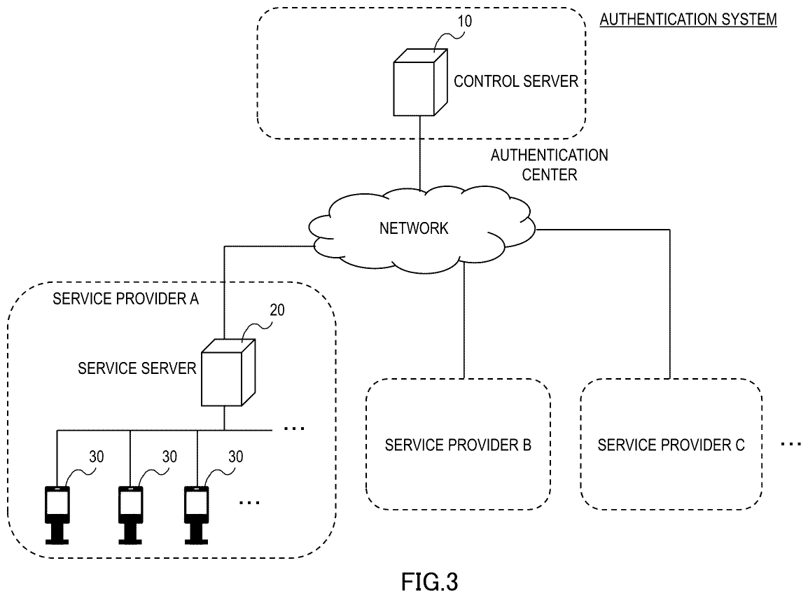

FIG. 3 is a diagram illustrating an example of a schematic configuration of an authentication system (information processing system) according to a first example embodiment. As illustrated in FIG. 3, the authentication system includes a plurality of service providers A to C and an authentication center.

The service provider is a business operator that provides a service to a user by using biometric authentication. The authentication system related to the present application disclosed is based on the premise that service providers belonging to various types of businesses and industries provide services using biometric authentication. It should be noted that the services provided by the service providers may be either paid or free of charge.

For example, business operators that provide rental housing services such as apartments, business operators that are workplaces of employees (workplaces of users), business operators that provide events such as concerts, and business operators that operate transportation means such as aircraft are examples of the service providers. Alternatively, business operators that provide accommodation services, business operators such as retail stores, business operators that provide financial services, and educational business operators are also included as service providers in the present application disclosed. In addition, the service providers are not limited to private business operators. A public institution such as a local government may also serve as a service provider.

The authentication center performs control, management, and the like related to biometric authentication for each of a plurality of service providers. The business operator (service provider) that provides a service using biometric authentication to a user (general consumer) is required to enter into a contract with the authentication center.

The authentication center includes a control server 10. The control server 10 achieves main functions of the authentication center. The control server 10 may be installed within a building of the authentication center, or may be a server installed on a network (cloud).

As described above, the service provider provides a service using biometric authentication to the user. For example, biometric authentication is performed in a case where the user goes to the office or returns to an apartment, and the user (an employee, a resident) who has a legitimate qualification is allowed to enter the office or the like. Alternatively, biometric authentication is performed in procedures such as ticket verification at an event venue or the like, check-in procedures at a hotel, and immigration procedures at an airport. Even in such services (procedures), the service is provided to the user who has a legitimate qualification. Alternatively, a payment procedure at a retail store or the like is performed using biometric authentication.

As illustrated in FIG. 3, each service provider includes a service server 20 and at least one or more authentication terminals 30. Apparatuses (the service server 20, the authentication terminal 30) provided by the service provider are connected to each other for mutual communication. Specifically, the service server 20 and authentication terminal 30 are connected by wired or wireless communication means.

The service server 20 is connected to the control server 10 via a network. The service server 20 may be installed in a building of the service provider, or may be installed on a cloud.

The service server 20 stores information necessary for providing a service to the user. Specifically, the service server 20 stores business information necessary for each service provider to provide a service using biometric authentication, and information necessary for biometric authentication. The service server 20 stores the business information and the information necessary for biometric authentication using a user management database. Details of the user management database will be described later.

For example, the service server 20 of a company where the user works stores, as the business information, information such as the user's (employee's) name, date of birth, employee number, department, and work location. In addition, the service server 20 of an event company that hosts an event stores, as the business information, information related to tickets purchased by event participants. Furthermore, the service server 20 of a retail store or the like stores, as the business information, information such as credit card information (payment information) necessary for payment processing.

Details of information necessary for biometric authentication stored in the service server 20 will be described later.

The authentication terminal 30 is an apparatus that functions as an interface for users who receive services. The authentication terminals 30 are installed at each service provider's respective service locations. More specifically, the authentication terminals 30 are installed in stores or other locations that users actually visit.

The authentication terminal 30 has functions and forms appropriate to the service provider's type of business and other factors. For example, the authentication terminal 30 installed at a workplace or event venue may be a gate apparatus equipped with a gate that restricts passage of the user (person to be authenticated). In addition, a tablet-type terminal may be used as the authentication terminal 30 installed at a retail store.

The configuration illustrated in FIG. 3 is an example and does not limit the configuration or the like of the authentication system disclosed in the present application. For example, the authentication center may include two or more control servers 10. In addition, the authentication system only needs to have at least one or more service providers participating. Furthermore, each service provider only needs to include at least one or more service servers 20 and at least one or more authentication terminals 30.

### Outline of Operation

Next, a schematic operation in the authentication system according to the first example embodiment will be described.

### Account Generation

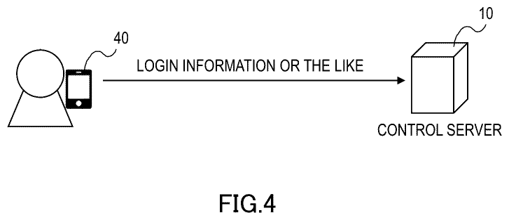

A user who wishes to receive a service from a service provider needs to generate an account in the system. Specifically, the user operates a terminal 40 possessed by the user to access the control server 10 (see FIG. 4).

The user inputs login information (for example, a login ID, a password), name, date of birth, contact information, and the like on a web page or the like provided by the control server 10. The control server 10, upon acquiring the login information and the like, generates an ID for identifying the user. In the following description, the ID generated by the control server 10 is referred to as a “system ID.” The control server 10 stores the generated system ID, the login information, and the like in the account management database in association with each other. Details of the account management database will be described later.

### Registration of Biometric Information

The user who wishes to receive a service using biometric authentication needs to register the user's own biometric information in the terminal 40.

Here, for a service using biometric authentication to be provided, authentication information generated from biometric information needs to be registered in advance with the service provider. For example, in a case where a service is provided using face recognition, a feature value (feature vector) generated from a face image needs to be registered in advance as authentication information. Alternatively, in a case where a service is provided using fingerprint authentication, a feature value generated from a fingerprint image needs to be registered in advance as authentication information.

In the following description, information that serves as an original source (basis) for generating authentication information, such as a face image or a fingerprint image, is referred to as “original biometric information.” In addition, a feature value generated from the original biometric information and registered in advance is referred to as “registered authentication information.”

The user who has completed generation of a system account needs to register original biometric information (for example, a face image) in the terminal 40 possessed by the user. The terminal 40 acquires the original biometric information using a GUI (Graphical User Interface) or the like. The terminal 40 stores the acquired original biometric information (for example, a face image) internally. In this manner, the terminal 40 stores the original biometric information that serves as the original source of authentication information used for biometric authentication.

<Selection of Service> The user who has completed system registration (creation of system account) and registration of original biometric information selects a service provider from which the user wishes to receive a biometric authentication service. The user selects a service provider, from among a plurality of service providers participating in the authentication system (service providers that have entered into a contract with the authentication center), from which the user desires to receive a service.

The control server 10 stores information on service providers participating in the authentication system. For example, the control server 10 stores a name, type of business, location, and the like of a service provider. The control server 10 holds information on each of the plurality of service providers and enables selection of a service provider by the user.

In a case where the user operates the terminal 40 and performs a predetermined operation on a portal site, the control server 10 displays, on the terminal 40, a GUI or the like that enables selection of a desired service (service provider) by the user. The control server 10 acquires a service (biometric authentication service) desired by the user using the GUI.

### User Registration

In a case where the service provider selected by the user is acquired, the control server 10 performs control related to “user registration,” which enables the selected service provider to provide a service using biometric authentication to the user.

Specifically, the control server 10 performs control for allowing the above selected service provider to acquire original biometric information stored in the terminal 40 of the user. The service provider generates registered authentication information from the acquired original biometric information, and by associating the generated registered authentication information with business information, becomes ready to provide a service to the user.

The user operates the terminal 40 to access the control server 10 and logs into the portal site for the user. In a case where the user performs a predetermined operation (for example, pressing a selection button for a service provider) on the portal site, the control server 10 displays a GUI including a list of service providers on the terminal 40.

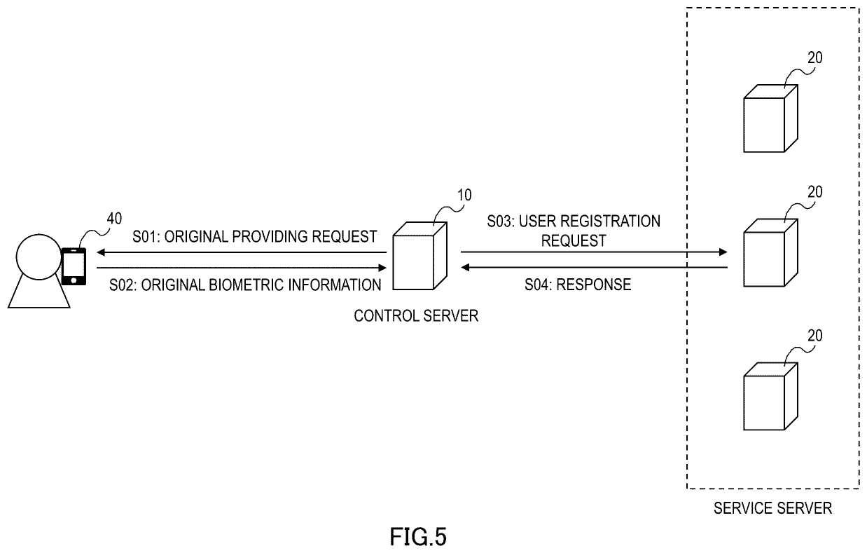

In a case where a service provider is selected, the control server 10 requests the user to provide original biometric information. Specifically, the control server 10 transmits an “original providing request” to the terminal 40 of the user (see step S01 in FIG. 5).

In a case where the original providing request is received, the terminal 40 transmits original biometric information of the user (for example, a face image) to the control server 10 (step S02).

The control server 10 notifies the service provider selected by the user of the system ID of the user, the acquired original biometric information, personal identification information, and the like. It should be noted that the personal identification information is information for identifying the user. As examples of the personal identification information, the name of the user, or a combination of the name and the date of birth, is exemplified.

The control server 10 transmits a “user registration request” including the system ID, the original biometric information, the personal identification information, and the like to the service server 20 of the service provider selected by the user (step S03).

The service server 20, which has received the user registration request, searches the user management database using the acquired personal identification information and identifies the user who desires user registration (provision of a service using biometric authentication). The service server 20 stores, in the entry of the identified user, the system ID and registration authentication information (for example, a feature value) acquired from the original biometric information.

The service server 20 transmits a response including a result of the user registration (success or failure of the user registration) to the control server 10 (step S04).

It should be noted that the control server 10 deletes the original biometric information (for example, a face image) acquired from the user at the timing of transmitting the user registration request to the service server 20 or at the timing of receiving a response to the request. In addition, the service server 20 deletes the original biometric information acquired from the control server 10 after generating registration authentication information (for example, a feature value).

### Provision of Service

The user who has completed the selection of a service visits the service provider in order to receive the provision of the service. For example, the user visits a facility, store, or the like of the service provider that provides the service selected by the user, such as an office, amusement park, event venue, retail store, or the like.

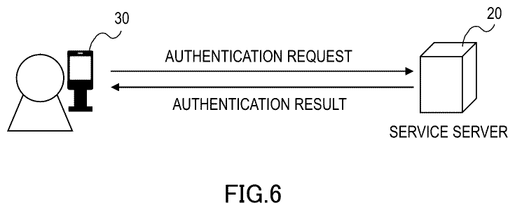

The authentication terminal 30 acquires biometric information of the user (person to be authenticated) who is to receive the provision of a service. For example, the authentication terminal 30 captures an image of the person to be authenticated and acquires biometric information (for example, a face image) corresponding to the original biometric information. The authentication terminal 30 transmits an authentication request including the acquired face image to the service server 20 (see FIG. 6). It should be noted that the authentication terminal 30 may transmit, together with the biometric information, other information (for example, the name of a purchased product, the price of the purchased product, and the like) to the service server 20, as necessary. Alternatively, the authentication terminal 30 may transmit, together with the biometric information (information for identifying an individual, an ID), information used for authentication processing (for example, credit card information) to the service server 20.

The service server 20 generates authentication information for matching from the acquired face image. For example, the service server 20 generates a feature value from the face image for matching. The service server 20 performs a matching processing (1-to-N matching; N is a positive integer, and the same applies hereinafter) using the generated authentication information for matching (hereinafter referred to as “matching authentication information”) and registration authentication information registered in the user management database.

The service server 20 identifies a user (a person to be authenticated) registered in the user management database through the matching processing.

The service server 20 performs authentication of the identified user using business information of the user. For example, the service server 20 of a company where the employee works determines “authentication success” in a case where the person to be authenticated is an employee of the company and is qualified to enter the office. Alternatively, the service server 20 installed at an event venue determines “authentication success” in a case where the ticket purchased by the person to be authenticated is valid. Alternatively, the service server 20 installed at a retail store determines “authentication success” in a case where the payment for a purchased product or the like by the person to be authenticated is successfully completed.

It should be noted that there are two types of service business operators among the service providers.

The first type of service provider is, in principle, a service provider that continues to retain registered authentication information (a feature value) and the like even if authentication of the person to be authenticated is successful. For example, a company where the user works or an apartment management company is exemplified as the first type of service provider. These service providers do not delete the registered authentication information and the like stored in the user management database even if authentication of the user (entry to or exit from an office, apartment, or the like) is successful. Alternatively, a retail store that provides a service related to face recognition-based payment of product prices using pre-registered credit card information is also exemplified as the first type of service provider. The retail store continues to store the credit card information and registered authentication information in association with each other.

A second type of service provider is, in principle, a service provider that deletes registered authentication information (a feature value) and the like in a case where authentication of the person to be authenticated is successful. For example, an event company and the like that hosts events is exemplified as the second type of service provider. The event company deletes the registered authentication information stored in the user management database in a case where authentication of the user is successful (in a case where the user enters the event venue using a purchased ticket).

It should be noted that even the same service provider may either continue to store registered authentication information or delete the registered authentication information, depending on the content of the service provided to the user. For example, a business operator that operates an amusement park or the like sells tickets that are limited to one-day use. In this case, the business operator serves as the second type of service provider. In a case where the business operator also sells tickets that allow entry to the amusement park or the like for a predetermined period (for example, an annual ticket), the business operator serves as a first type of service provider. In this case, the business operator continues to store the registered authentication information until the expiration of the annual ticket.

The service server 20 transmits an authentication result (authentication success, authentication failure) to the authentication terminal 30.

The authentication terminal 30 executes processing in accordance with the authentication result. For example, in a case where authentication success is received, the authentication terminal 30 installed at the office opens a gate and allows the person to be authenticated to pass through the gate. Alternatively, the authentication terminal 30 installed at the event venue allows the person to be authenticated to pass through the gate in a case where authentication success is received. Alternatively, the authentication terminal 30 installed at the retail store notifies the person to be authenticated that payment for the product has been completed in a case where authentication success is received.

### Notification of Authentication Success

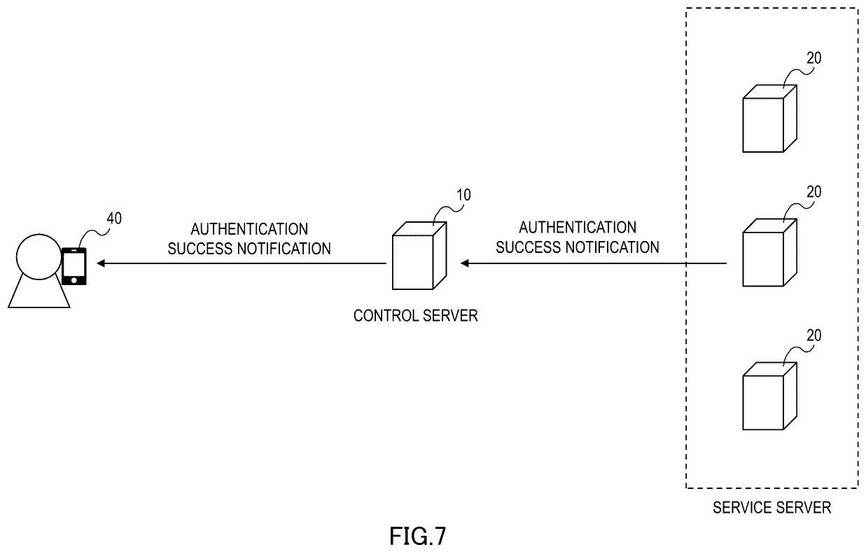

In addition, in a case where authentication of the person to be authenticated is successful, the service server 20 notifies the user to that effect. The service server 20 notifies the terminal 40 possessed by the user of the details of the authentication result via the control server 10. Specifically, in a case where the authentication of the person to be authenticated succeeds, the service server 20 transmits an authentication success notification, which includes the system ID of the authentication success person (the person to be authenticated who has been determined as having succeeded in authentication), detailed information on the authentication process, and the status of the authentication information, to the control server 10 (see FIG. 7).

The detailed information on the authentication processing includes, for example, the authentication date and time, the authentication location, and details of the provided service (for example, the name of the purchased product, the payment amount, and the like).

For example, the service server 20 of the workplace of the person to be authenticated generates, as the details of the provided service, the clock-in date and time and the office name of the authentication success person. Alternatively, for example, the service server 20 of the retail store generates, as the details of the provided service, the store visit date and time, the store name, the purchased product, the payment amount, and the like of the authentication success person.

The status of the authentication information is set to indicate the status (retention, deletion) of the registered authentication information (feature value) of the authentication success person after the authentication processing.

For example, the service server 20 of a first service provider, such as the workplace of the person to be authenticated, sets “authentication information retention” as the status of the authentication information. Alternatively, the service server 20 of a second service provider, such as the event company, sets “authentication information deletion” as the status of the authentication information.

The control server 10 receives the authentication success notification. The control server 10 searches the account management database using the system ID included in the authentication success notification as a key, and identifies the corresponding entry (user). The control server 10 transmits (forwards) the authentication success notification received from the service server 20 to the terminal 40 of the identified user.

The terminal 40 generates an authentication history based on the received authentication success notification. In addition, the terminal 40 notifies the user of the fact of reception of the notification each time the authentication success notification is received. For example, the terminal 40 displays the content included in the authentication success notification (the details of the authentication processing and the status of the authentication information) by means such as pop-ups.

Alternatively, the terminal 40 displays the authentication history in a case where a predetermined button (a history check button) is pressed. The user can check for the presence or absence of unauthorized use or the like by confirming the authentication history.

In this manner, in a case where the service provider selected in advance by the user succeeds in authenticating the user, the fact of the authentication success is notified to the user. It should be noted that, as described above, the service server 20 may transmit the authentication success notification to the terminal 40 via the control server 10, or may alternatively transmit the authentication success notification directly to the terminal 40 without going through the control server 10. In this case, the service server 20 only needs to acquire the user's contact information (such as an email address that the terminal 40 can receive) in the case of acquiring the business information.

Next, details of the individual apparatuses included in the authentication system according to the first example embodiment will be described.

### Control Server

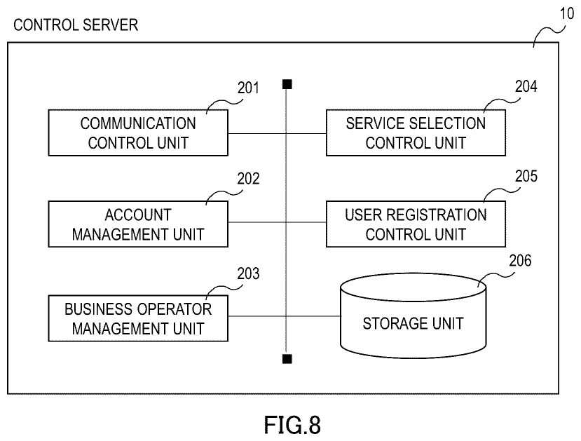

FIG. 8 is a diagram illustrating an example of a processing configuration (processing modules) of the control server 10 according to the first example embodiment. Referring to FIG. 8, the control server 10 includes a communication control unit 201, an account management unit 202, a business operator management unit 203, a service selection control unit 204, a user registration control unit 205, and a storage unit 206.

The communication control unit 201 is means for controlling communication with other apparatuses. Specifically, the communication control unit 201 receives data (packets) from the service server 20. In addition, the communication control unit 201 transmits data to the service server 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The account management unit 202 is means for managing accounts of users. The account management unit 202 acquires information necessary for generating an account of the user in a case where the user operates the terminal 40 to access a predetermined webpage or the like.

Specifically, the account management unit 202 acquires personal information such as login information, name, date of birth, and contact information (for example, an email address that the terminal 40 can receive). After acquiring the login information and the like, the account management unit 202 generates a system ID for identifying the user. The system ID may be any type of information as long as the system ID can uniquely identify the user. For example, the account management unit 202 may assign a unique value each time an account is created and use the assigned value as the system ID.

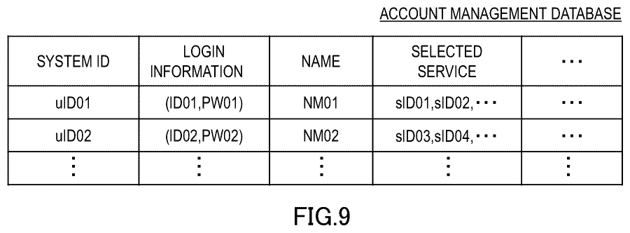

The account management unit 202 stores, in the account management database, the generated system ID, login information, name, and the like in association with each other (see FIG. 9). It should be noted that the account management database shown in FIG. 9 is merely an example, and is not intended to limit the items to be stored or the like. For example, the account generation date and time or the like may also be stored in the account management database.

In addition, the account management unit 202 acquires login information for logging into a portal site from the terminal 40 of the user. The account management unit 202 performs authentication using the login information.

The business operator management unit 203 is means for managing service providers (service business operators) participating in the authentication system. The business operator management unit 203 acquires business operator information to be registered in the system (the name of the service provider, type of business, location, address of the service server 20, and the like) by a staff member or the like of each service provider.

For example, the business operator management unit 203 may provide each service provider with an interface for inputting business operator information or the like. Alternatively, each service provider may send to the authentication center a USB (Universal Serial Bus) memory or the like in which the business operator information or the like is stored. The business operator management unit 203 may acquire the business operator information or the like from a staff member or the like of the authentication center.

The business operator management unit 203 generates an ID (a business operator ID) for a service provider from which the business operator information or the like has been acquired. The business operator management unit 203 associates and stores the generated business operator ID with the acquired business operator information or the like.

The service selection control unit 204 is means for controlling selection of a biometric authentication service (service provider) by the user. The service selection control unit 204 enables the user to select a service provider from among a plurality of service providers that provide a service using biometric authentication, the selected service provider being one from which the user wishes to receive the service.

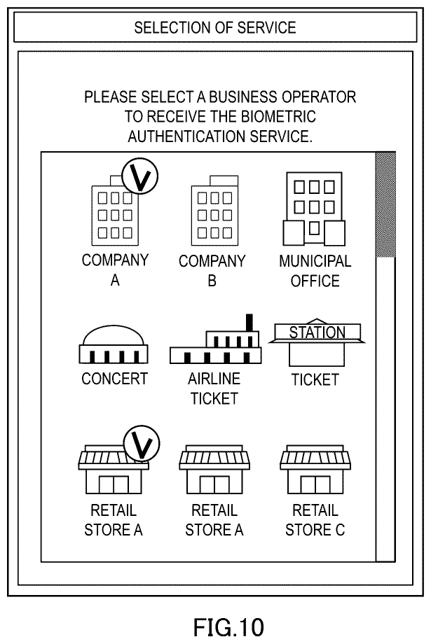

In a case where the user operates the terminal 40 to log into a portal site and performs a predetermined operation on the portal site, the service selection control unit 204 displays, for example, a GUI such as that shown in FIG. 10 on the terminal 40.

In displaying the above GUI, the service selection control unit 204 performs a display that allows the user to distinguish between a service provider that has already been selected and a service provider that has not yet been selected. In the example of FIG. 10, a service provider with a check mark in the upper right of an icon representing a service business operator indicates a service provider already selected, and a service provider without a check mark indicates a service provider not yet selected.

It should be noted that the service selection control unit 204 uses the business operator information and the information registered in the account management database in order to display the GUI such as that shown in FIG. 10. Specifically, the service selection control unit 204 refers to the business operator information and generates a list of service providers that have entered into a contract with the authentication center. In addition, the service selection control unit 204 refers to a selected service field in the account management database and acquires a service provider (business operator ID of the service provider) that has already been selected by the user.

In addition, the service selection control unit 204 may also provide the user with more detailed information on each service provider (for example, type of business, provided service, store location, and the like) in the case of displaying the list of service providers.

The service selection control unit 204 passes information on the service provider selected by the user (for example, the business operator ID of the service provider for which user registration has been requested) to the user registration control unit 205.

The user registration control unit 205 is means for controlling “user registration” by the control server 10. The user registration control unit 205 controls the “user registration” that enables a service provider selected by the user to provide the user with a service using biometric authentication.

In a case where the user selects a service provider, the user registration control unit 205 transmits an “original providing request” to the terminal 40 possessed by the user. The user registration control unit 205 receives original biometric information of the user (for example, a face image) from the terminal 40.

The user registration control unit 205 transmits a user registration request, including the user's system ID, original biometric information, personal identification information, and the like, to the service server 20 of the service provider corresponding to the service selected by the user.

It should be noted that the user registration control unit 205 acquires the system ID and personal identification information (for example, a name or a combination of a name and a date of birth) from the account management database.

The user registration control unit 205 receives a response to the user registration request (positive response, negative response).

In a case where a positive response (successful user registration) is received, the user registration control unit 205 registers the business operator ID of the service provider selected by the user in the account management database. In addition, in a case where the positive response is received, the user registration control unit 205 notifies the user that the user registration for the selected service provider has been successfully completed.

In a case where a negative response (failed user registration) is received, the user registration control unit 205 notifies the user of that fact.

The storage unit 206 is means for storing information necessary for the operation of the control server 10.

### Service Server

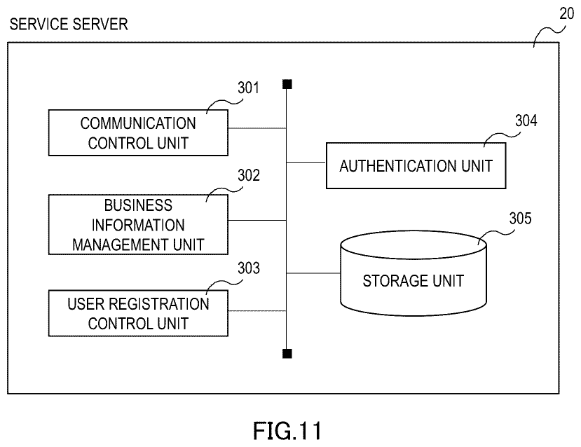

FIG. 11 is a diagram illustrating an example of a processing configuration (processing modules) of the service server 20 according to the first example embodiment. Referring to FIG. 11, the service server 20 includes a communication control unit 301, a business information management unit 302, a user registration control unit 303, an authentication unit 304, and a storage unit 305.

The communication control unit 301 is means for controlling communication with other apparatuses. For example, the communication control unit 301 receives data (packets) from the control server 10. In addition, the communication control unit 301 transmits data to the control server 10. The communication control unit 301 passes data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The business information management unit 302 is means for performing management and control related to business information necessary for the service provider to provide a business operation.

The business information management unit 302 acquires business information necessary for providing services of its own company or organization using any arbitrary means. For example, the business information management unit 302 of a user's employer acquires, as business information, information such as the employee's name, date of birth, employee number, department, and work location.

The business information management unit 302 may acquire the above business information from a staff member or the like of the service provider, or may directly acquire the business information from the user using means such as a webpage or the like.

The business information management unit 302 manages the business information using the user management database.

A more detailed description of the business information management unit 302 will be omitted. This is because the details of the business information in individual services and the method of acquiring such information are different from a purpose of the present application.

The user registration control unit 303 is means for controlling user registration by the service provider. The user registration control unit 303 processes a user registration request received from the control server 10.

In a case where the user registration request is received, the user registration control unit 303 searches the user management database using personal identification information (for example, a name) included in the user registration request as a key, and identifies a corresponding user (entry).

In a case where the corresponding user is registered in the user management database, the user registration control unit 303 generates registered authentication information from the acquired original biometric information (for example, a face image). For example, in a case where the face image is acquired, the user registration control unit 303 generates, as the registered authentication information, a feature value (feature vector) corresponding to a face recognition algorithm adopted by own company.

Note that since an existing technology can be used to generate the feature value, a detailed description thereof will be omitted. For example, the user registration control unit 303 extracts eyes, nose, mouth, and the like as feature points from the face image. Next, the user registration control unit 303 calculates the location of an individual feature point and the distance between feature points as the feature values and generates the feature vector formed by the plurality of feature values (vector information that characterizes the face image).

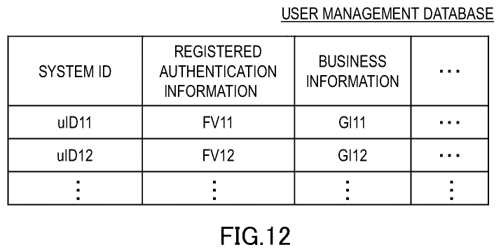

In a case where the registered authentication information (for example, a feature value) is generated, the user registration control unit 303 associates and stores the system ID, the generated registered authentication information (feature value), and the business information in the user management database (see FIG. 12).

It should be noted that the user management database shown in FIG. 12 is merely an example and is not intended to limit the items to be stored or the like. For example, the date and time of the user registration or the like may also be registered in the user management database.

In a case where user registration is successfully completed, the user registration control unit 303 transmits a positive response indicating successful user registration to the control server 10. It should be noted that, after generating registered authentication information (for example, a feature value) and registering the generated registered authentication information in the user management database, the user registration control unit 303 deletes the original biometric information acquired from the control server 10.

In a case where the user registration is not successfully completed, the user registration control unit 303 transmits a negative response indicating failure of the user registration to the control server 10. For example, the negative response is transmitted to the control server 10 in a case where the personal identification information (for example, a name) received from the control server 10 is not registered in the user management database, or in a case where valid registered authentication information cannot be generated from the original biometric information, or the like.

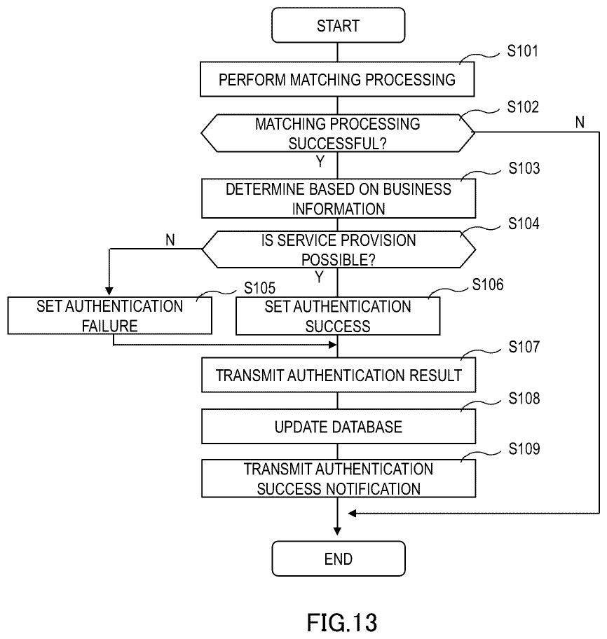

The authentication unit 304 is means for performing biometric authentication of a person to be authenticated. FIG. 13 is a flowchart illustrating an example of an operation of the authentication unit 304 according to the first example embodiment. Referring to FIG. 13, the operation of the authentication unit 304 will be described.

In a case where an authentication request is received from the authentication terminal 30, the authentication unit 304 performs a matching processing using biometric information (step S101).

Specifically, the authentication unit 304 generates matching authentication information from biometric information included in the authentication request. For example, in a case where a face image is acquired, the authentication unit 304 generates a feature value corresponding to a face recognition algorithm adopted by the company. The authentication unit 304 performs a matching processing using the generated matching authentication information (feature value) and the registered authentication information (feature value) in the user management database.

Specifically, the authentication unit 304 calculates a similarity between a feature value (a feature vector) as a matching target and each of a plurality of registered feature values. As the similarity, a chi-square distance, a Euclidean distance, or the like can be used. It should be noted that the greater the distance is, the lower the similarity becomes, and the smaller the distance is, the higher the similarity becomes.

If no feature value having a similarity equal to or greater than a predetermined value exists, the authentication unit 304 determines that the matching processing has failed. If a feature value having a similarity equal to or greater than the predetermined value exists, the authentication unit 304 determines that the matching processing has succeeded. In a case where the matching processing succeeds, a user of an entry having the feature value (the registered authentication information) with the highest similarity among a plurality of entries registered in the user management database is specified as the person to be authenticated.

In a case where the matching processing fails (step S102, No branch), the authentication unit 304 terminates the processing. In this case, the authentication unit 304 may notify the authentication terminal 30 that the authentication has failed. Alternatively, the authentication unit 304 may store, as a log, the fact that the matching processing has failed and details of the matching processing, in order to confirm the soundness of the face recognition.

In a case where the matching processing succeeds (step S102, Yes branch), the authentication unit 304 determines whether provision of a service to the person to be authenticated identified through the matching processing is possible, using business information of the person to be authenticated. The authentication unit 304 performs a determination as to whether the service can be provided based on the business information (step S103).

For example, in a case where the authentication unit 304 of the service server 20 of a company where an employee works determines that the person to be authenticated is an employee of the company and is qualified to enter the office, the authentication unit 304 determines that the provision of the service is possible. Alternatively, in a case where the service server 20 of an event company determines that a ticket purchased by the person to be authenticated is valid, the service server 20 determines that the provision of the service is possible. Alternatively, in a case where the authentication unit 304 of the service server 20 of a retail store or the like succeeds in payment of a product price using credit card information or the like, the authentication unit 304 determines that the provision of the service is possible.

A more detailed description of authentication processing using business information in each service provider will be omitted. This is because the processing specific to each service provider is different from the purpose of the present application.

In a case where the provision of the service is not possible (step S104, No branch), the authentication unit 304 sets “authentication failure” as an authentication result (step S105).

In a case where the provision of the service is possible (step S104, Yes branch), the authentication unit 304 sets “authentication success” as an authentication result (step S106).

The authentication unit 304 transmits the authentication result (authentication success, authentication failure) to the authentication terminal 30 (step S107).

In the case of authentication failure, the authentication unit 304 transmits a negative response indicating that fact to the authentication terminal 30.

In the case of authentication success, the authentication unit 304 transmits a positive response indicating that fact to the authentication terminal 30. At that time, the authentication unit 304 transmits, as necessary, a positive response including information necessary to provide a service to the user to the authentication terminal 30. In the above example of issuing a certificate of residence, information necessary for issuing (printing) the certificate of residence is transmitted to the authentication terminal 30.

In addition, in the case of authentication success, the authentication unit 304 updates the user management database as necessary (database update; step S108). More specifically, the authentication unit 304 deletes at least the registered authentication information of the person who has successfully authenticated, in accordance with the content of the authentication processing.

For example, in a case where the authentication processing relates to entry or exit of the person to be authenticated (such as going to work at an office or returning home to an apartment), the authentication unit 304 does not perform any particular processing (does not delete the registered authentication information). Alternatively, even in a case where payment for a product purchased by the person to be authenticated is made using credit card information, the authentication unit 304 does not perform any particular processing.

In this manner, in a case where the registered authentication information of the person who has successfully authenticated is not deleted, the authentication unit 304 sets “authentication information retained” as a status of the authentication information.

In a case where the person to be authenticated enters an event venue or the like using a purchased ticket, the authentication unit 304 deletes the registered authentication information of the person to be authenticated (deletes the corresponding entry in the user management database). In this case, the authentication unit 304 sets the status of the authentication information to “authentication information deletion.” Whether or not the registered authentication information is deleted is predetermined in accordance with the service provided to the user. Alternatively, the deletion of the registered authentication information (the entry including the registered authentication information) may be determined based on information included in the business information. For example, in a case where the ticket purchased by the user is a reusable ticket such as an “annual pass,” the authentication unit 304 does not delete the registered authentication information.

in the case of authentication success, the authentication unit 304 transmits an authentication success notification to the control server 10 (step S109).

Specifically, the authentication unit 304 transmits an authentication success notification to the control server 10, the authentication success notification including the system ID of the person to be authenticated (the user specified through the matching processing), detailed information of the authentication process, and the status of the authentication information.

The authentication unit 304 acquires the above-described system ID from the entry (an entry of the user management database) specified through the matching processing.

The authentication unit 304 generates an authentication date and time based on the date and time at which the authentication request received from the authentication terminal 30 was processed, and generates an authentication location based on the installation location of the authentication terminal 30. In addition, the authentication unit 304 generates details of the provided service based on the content of the authentication processing using the business information.

For example, in a case where the person to be authenticated has arrived at their workplace, the authentication unit 304 generates detailed information of the authentication processing including information such as “authentication date and time=Nov. 7, 2022, 08:30,” “authentication location=head office building,” and “details of the provided service=clock-in.” Alternatively, in a case where the person to be authenticated has purchased a product at a retail store, the authentication unit 304 generates detailed information of the authentication processing including information such as “authentication date and time=Nov. 7, 2022, 13:00,” “authentication location=store in front of station,” and “details of the provided service=nutritional drink purchase, 300 yen.”

It should be noted that, in a case where an event such as the user having left their place of employment, the user having moved out from an apartment, or the expiration of the validity period of an annual passport has occurred, the entry corresponding to the user is deleted from the user management database. In such a case, it is not possible for the authentication of the user to succeed, and therefore, neither an update of the user management database nor a transmission of the authentication success notification is carried out.

The storage unit 305 is means for storing information necessary for the operation of the service server 20.

### Authentication Terminal

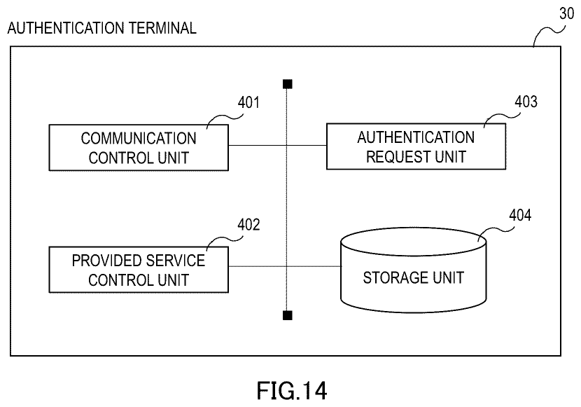

FIG. 14 is a diagram illustrating an example of a processing configuration (processing modules) of the authentication terminal 30 according to the first example embodiment. Referring to FIG. 14, the authentication terminal 30 includes a communication control unit 401, a provided service control unit 402, an authentication request unit 403, and a storage unit 404.

The communication control unit 401 is means for controlling communication with other apparatuses. Specifically, the communication control unit 401 receives data (packets) from the service server 20. In addition, the communication control unit 401 transmits data to the service server 20. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit that receives data from other apparatuses and a function as a transmitting unit that transmits data to other apparatuses.

The provided service control unit 402 is means for performing control related to a service to be provided to the user. The provided service control unit 402 realizes a function that is assigned to the authentication terminal 30.

In a case where the user desires to receive a service, the provided service control unit 402 acquires biometric information (for example, a face image) of the user (the person to be authenticated). For example, the provided service control unit 402 captures an image of an area in front of the apparatus itself periodically or at a predetermined timing. The provided service control unit 402 determines whether or not a human face image is included in the acquired image, and in a case where a face image is included, the provided service control unit 402 extracts the face image from the acquired image data.

It should be noted that, since existing technologies can be used for the face image detection processing and the face image extraction processing performed by the provided service control unit 402, a detailed description thereof will be omitted. For example, the provided service control unit 402 may extract a face image (face region) from image data by using a trained model that has been trained by a CNN (Convolutional Neural Network). Alternatively, the provided service control unit 402 may extract a face image by using a technique such as template matching or the like.

The provided service control unit 402 passes the acquired biometric information (for example, a face image) to the authentication request unit 403.

The authentication request unit 403 is means for requesting authentication of the person to be authenticated to the service server 20. The authentication request unit 403, in a case where authentication of the person to be authenticated becomes necessary, transmits an authentication request including biometric information of the person to be authenticated (the user who is in front of the authentication terminal 30) to the service server 20.

The authentication request unit 403 receives an authentication result (authentication success, authentication failure) from the service server 20. The authentication request unit 403 passes the received authentication result to the provided service control unit 402.

For example, in a case where authentication success is received, the provided service control unit 402 of the authentication terminal 30 installed at the workplace of the user opens a gate and permits the entry of the person to be authenticated.

In a case where authentication failure is received, the provided service control unit 402 may output a predetermined message or the like.

It should be noted that a more detailed description related to the provided service control unit 402 included in the authentication terminal 30 of each service provider is omitted. This is because the realization of the functions of the authentication terminal 30 by the provided service control unit 402 is different from the purpose of the present application disclosed.

The storage unit 404 is means for storing information necessary for the operation of the authentication terminal 30.

### Terminal

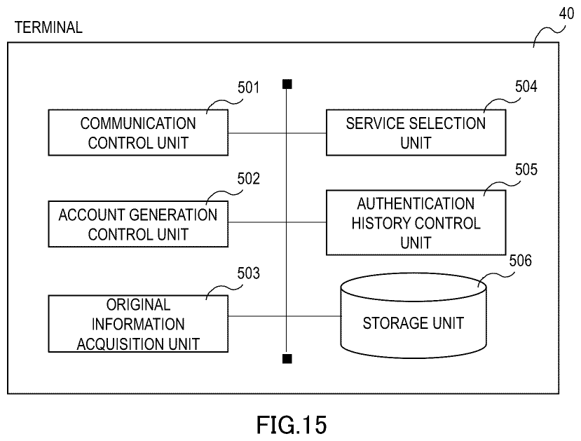

FIG. 15 is a diagram illustrating an example of a processing configuration (processing modules) of the terminal 40 according to the first example embodiment. Referring to FIG. 15, the terminal 40 includes a communication control unit 501, an account generation control unit 502, an original information acquisition unit 503, a service selection unit 504, an authentication history control unit 505, and a storage unit 506.

The communication control unit 501 is means for controlling communication with other apparatuses. For example, the communication control unit 501 receives data (packets) from the control server 10. In addition, the communication control unit 501 transmits data to the control server 10. The communication control unit 501 passes data received from other apparatuses to other processing modules. The communication control unit 501 transmits data acquired from other processing modules to other apparatuses. In this manner, other processing modules perform transmission and reception of data with other apparatuses via the communication control unit 501. The communication control unit 501 includes a function as a receiving unit for receiving data from other apparatuses, and a function as a transmitting unit for transmitting data to other apparatuses.

The communication control unit 501, in response to a request from the control server 10 that performs management related to biometric authentication for each of a plurality of service providers, transmits original biometric information stored in the storage unit 506 to the service server 20 of a service provider selected by the user, via the control server 10. In addition, the communication control unit 501 receives, either directly or indirectly, an authentication success notification from the service server 20 of the service provider selected by the user from among the plurality of service providers, the selected service provider having succeeded in biometric authentication of the user.

The account generation control unit 502 is means for controlling generation of a user account by the user. The account generation control unit 502 accesses a predetermined web page or the like provided by the control server 10, in accordance with an operation performed by the user.

The account generation control unit 502, in accordance with an operation performed by the user, inputs login information, name, date of birth, contact information, or the like into the web page.

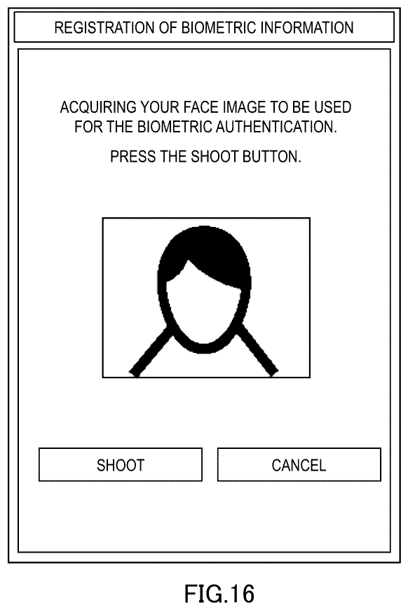

The original information acquisition unit 503 is means for acquiring biometric information (original biometric information) of the user. The original information acquisition unit 503 displays a GUI or the like for acquiring original biometric information (for example, a face image), in accordance with an operation performed by the user. For example, the original information acquisition unit 503 acquires original biometric information using a GUI such as that shown in FIG. 16.

The original information acquisition unit 503 stores the acquired original biometric information (for example, a face image) in the storage unit 506. At that time, the original information acquisition unit 503 may perform encryption, encoding, or the like on the acquired original biometric information and store the encrypted original biometric information in the storage unit 506. That is, the terminal 40 possessed by the user may hold the encrypted original biometric information. The encrypted original biometric information may be decrypted in a case where the original biometric information is transmitted to the control server 10. Alternatively, information for decrypting the encrypted original biometric information (for example, a common key) may be shared between the terminal 40 and the control server 10, and the control server 10 may decrypt the encrypted original biometric information.

It should be noted that, in principle, the terminal 40 does not delete original biometric information (for example, a face image) of the user. That is, the terminal 40 does not delete the original biometric information stored in the storage unit 506 unless there is an explicit instruction from the user.

The service selection unit 504 is means for enabling selection of a biometric authentication service by the user. The service selection unit 504 logs into a portal site provided by the control server 10, in accordance with an operation performed by the user. The service selection unit 504 transmits information of a service provider selected by the user to the control server 10 by using a GUI provided by the control server 10.

The service selection unit 504 receives an original providing request from the control server 10. In a case where the request is received, the service selection unit 504 transmits the original biometric information stored in the storage unit 506 to the control server 10. The original biometric information is transmitted, via the control server 10, to the service server 20 of the service provider selected by the user.

The authentication history control unit 505 is means for performing control related to authentication history of the user. The authentication history control unit 505 processes an authentication success notification received from the control server 10. The authentication history control unit 505 performs control related to a history of successful biometric authentication at the service provider, in accordance with the reception of the authentication success notification.

The authentication success notification includes detailed information of an authentication processing that has been successfully performed by the service provider, and a status of authentication information used for biometric authentication by the service provider.

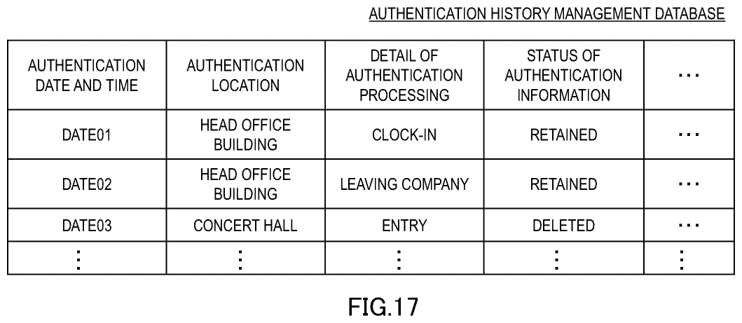

The authentication history control unit 505 stores detailed information of the authentication processing and the status of the authentication information, both of which are included in the authentication success notification, in an authentication history management database (see FIG. 17). The authentication history control unit 505 generates a history related to biometric authentication of the user by storing the detailed information of the authentication processing and the status of the authentication information in the authentication history management database. It should be noted that the authentication history management database shown in FIG. 17 is merely an example, and is not intended to limit the items to be stored or the like.

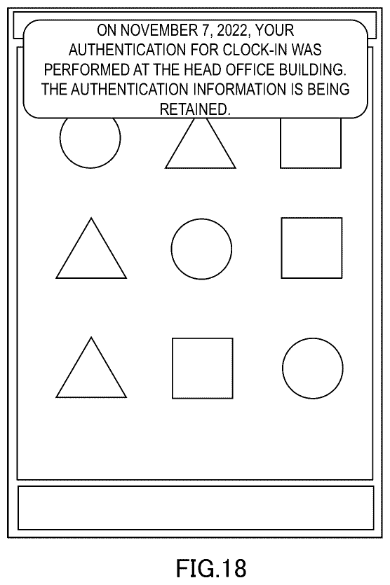

In addition, in a case where an authentication success notification is received, the authentication history control unit 505 notifies the user (the owner of the terminal 40) of the fact that authentication of the user has been performed. For example, the authentication history control unit 505 displays information related to authentication of the user by using a popup notification such as that shown in FIG. 18, each time an authentication success notification is received. That is, the authentication history control unit 505 displays a message including detailed information of the authentication processing and the status of the authentication information, each time an authentication success notification is received.

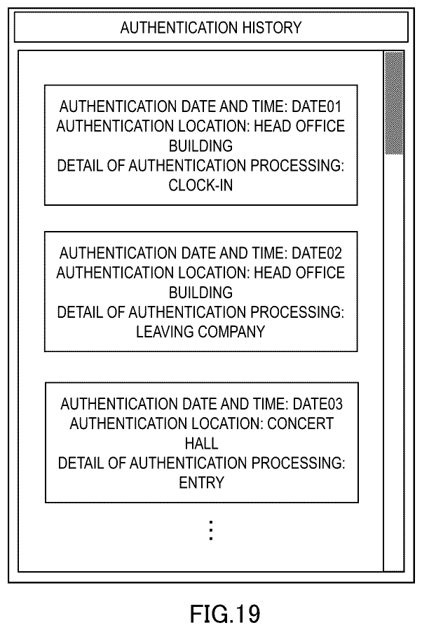

Alternatively, in a case where the user performs a predetermined operation (for example, presses an authentication history button), the authentication history control unit 505 displays a list of authentication history stored in the authentication history management database (see FIG. 19). That is, the authentication history control unit 505 displays a history related to biometric authentication stored in the authentication history management database, in accordance with a predetermined operation performed by the user.

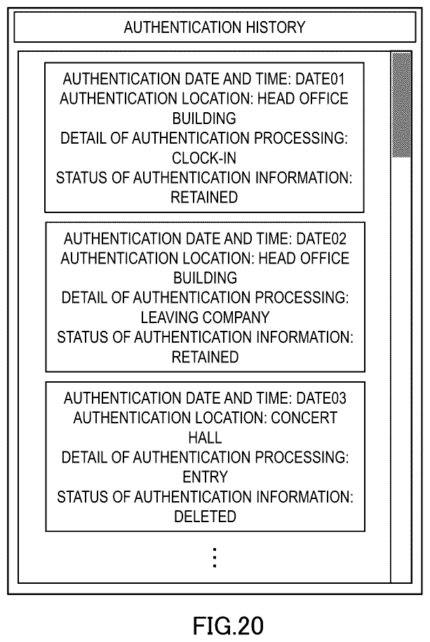

It should be noted that, in performing a list display of authentication history, the authentication history control unit 505 may display detailed information of the authentication processing, as shown in FIG. 19, or may display, in addition to the detailed information of the authentication processing, the status of the authentication information, as shown in FIG. 20.

The storage unit 506 is means for storing information necessary for the operation of the terminal 40. The storage unit 506 stores original biometric information, which serves as the original source of authentication information used for biometric authentication. It should be noted that, for example, the original biometric information is a face image, and the authentication information is a feature value generated from the face image.

### System Operation

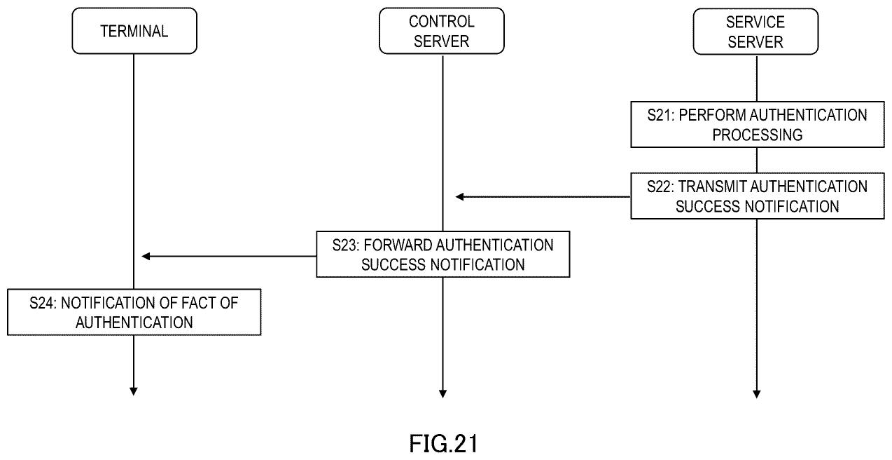

Next, operations in the authentication system according to the first example embodiment will be described. It should be noted that a description of operations related to account generation or the like will be omitted. FIG. 21 is a sequence diagram illustrating an example of the operation of the authentication system according to the first example embodiment.

In a case where an authentication request is received from the authentication terminal 30, the service server 20 performs authentication processing (step S21).

In a case where authentication of the person to be authenticated is successful, the service server 20 transmits an authentication success notification to the control server 10 (step S22).

The control server 10 forwards the authentication success notification to the terminal 40 of the person who has been successfully authenticated (step S23).

The terminal 40 notifies the user of the fact that authentication processing has been performed (the fact that authentication has succeeded and the details thereof) (notification of the fact of authentication; step S24).

Next, variations according to the first example embodiment will be described.

### Variation 1 According to the First Example Embodiment

A user may select a service provider by using a predetermined code. For example, a management code that enables the user to easily designate a service provider from among a large number of service providers may be used. For example, the control server 10 displays a GUI for prompting input of a management code in a case where the user selects a predetermined icon from among the list of icons shown in FIG. 10. The control server 10 treats the service provider corresponding to the management code input by the user as the service provider selected by the user.

Alternatively, the control server 10 may treat the management code input by the user in the manner of a password. Specifically, in a case where the user selects a service provider, the control server 10 prompts the user to input a management code of the selected service provider. In a case where the management code input by the user matches a predetermined management code of the selected service provider, the control server 10 may accept the selection of the service provider by the user. In other words, the control server 10 rejects the selection of the service provider by the user in a case where the above two management codes do not match.

### Variation 2 According to the First Example Embodiment

In the above example embodiment, a case has been described in which, at the time of user registration, the service provider (the service server 20) identifies the user by using personally identifiable information. However, the selection of the user may be performed by using an ID (hereinafter referred to as an individual ID) used by the service provider to manage users (customers).

Specifically, in a case where the user selects a service provider, the control server 10 transmits to the terminal 40 a URL (Uniform Resource Locator) for redirection into which the system ID of the user is embedded. The URL for redirection is a URL for logging into a portal site (account) of the service provider selected by the user.

In a case where the user logs into a login page of the service provider in accordance with the received URL for redirection, the service server 20 acquires an individual ID (login ID) of the user and the system ID embedded in the URL for redirection.

The service server 20 searches the user management database by using the acquired individual ID and identifies a corresponding entry (user). The service server 20 stores the system ID in the identified entry.

In this manner, user registration may be realized by using the URL for redirection into which the system ID is embedded.

As described above, in the authentication system according to the first example embodiment, the original biometric information stored in the terminal 40 of the user is provided to the service server 20 of the service provider selected by the user. The service server 20 generates registered authentication information from the original biometric information of the user and enables provision of a service using biometric authentication to the user by storing the generated registered authentication information in association with business information. In a case where the user receives a biometric authentication service from the service provider, the service server 20 transmits an authentication success notification to the terminal 40 of the user via the control server 10. In accordance with reception of the authentication success notification, the terminal 40 displays a popup notification indicating that biometric authentication has been performed by the service provider, or displays a list of past authentication results. The user can verify whether or not unauthorized biometric authentication has been performed, by referring to the popup notification or the list display of authentication history. In other words, the user can detect unauthorized biometric authentication based on the popup notification or the list display of authentication history.

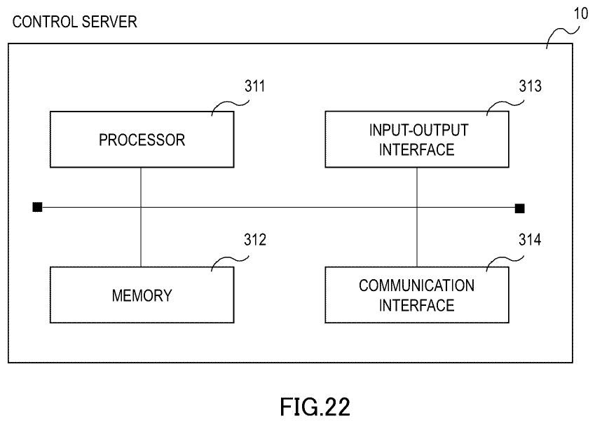

Next, a hardware configuration of an individual apparatus that constitutes the authentication system will be described. FIG. 22 is a diagram illustrating an example of a hardware configuration of the control server 10.

The control server 10 can be configured by an information processing apparatus (a so-called computer) and has a configuration illustrated as an example in FIG. 22. For example, the control server 10 includes a processor 311, a memory 312, an input-output interface 313, a communication interface 314, and the like. The above-described components such as the processor 311 are connected via an internal bus or the like and are configured to be capable of communicating with each other.

However, the configuration shown in FIG. 22 is not intended to limit the hardware configuration of the control server 10. The control server 10 may include hardware not illustrated in the figure, and may omit the input-output interface 313 as needed. In addition, the number of components such as the processor 311 included in the control server 10 is not intended to be limited to the example shown in FIG. 22, and, for example, a plurality of processors 311 may be included in the control server 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and so on. The memory 312 stores an OS program, an application program, and various kinds of data.

The input-output interface 313 is an interface for a display apparatus and an input apparatus not illustrated. The display apparatus is, for example, a liquid crystal display or the like. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes a NIC (Network Interface Card) and so on.

The functions of the control server 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

It should be noted that the service server 20, the authentication terminal 30, the terminal 40, and the like can also be configured by information processing apparatuses in the same manner as the control server 10, and since the specific hardware configurations of the service server 20, the authentication terminal 30, the terminal 40, and the like are not different from that of the control server 10, a detailed description thereof will be omitted. For example, it is sufficient for the authentication terminal 30 to include a camera apparatus for capturing an image of the person to be authenticated.

The control server 10, which is an information processing apparatus, is equipped with a computer, and the functions of the control server 10 can be realized by causing the computer to execute a program. In addition, the control server 10 executes a control method of the control server 10 by using the program. Similarly, the terminal 40, which is an information processing apparatus, includes a computer and can realize its functions by causing the computer to execute a program. In addition, the terminal 40 executes a control method of the terminal 40 by the program.

### Variations

It should be noted that the configurations, operations, and the like of the authentication system described in the above example embodiment are merely examples and are not intended to limit the configuration or the like of the system.

In the above example embodiment, selection of a service provider by the user and provision (opt-in) of original biometric information associated with the selection have been described. The control server 10 and the terminal 40 make it possible for the user to identify the opted-in service provider by placing a check mark on the icon of the service provider, as shown in FIG. 10. The control server 10 and the terminal 40 may also enable opt-out, in which registered authentication information is deleted from the opted-in service provider. In this case, in FIG. 10, in a case where the user selects a service provider that has already been selected (an opted-in service provider), the control server 10 transmits a user deregistration request including the system ID of the user to the service server 20 of the selected service provider. The service server 20 deletes registered authentication information and the like of the user corresponding to the system ID.

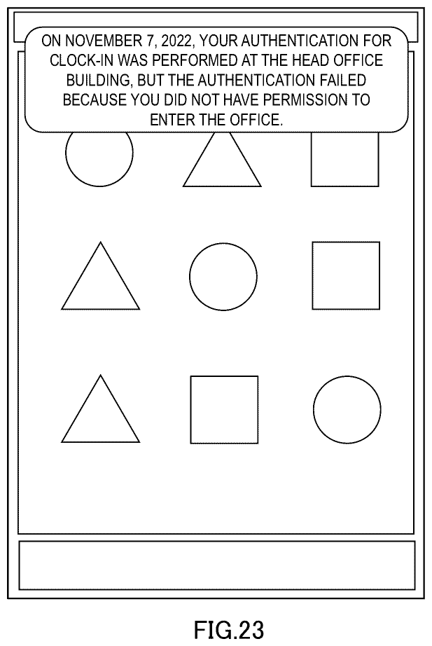

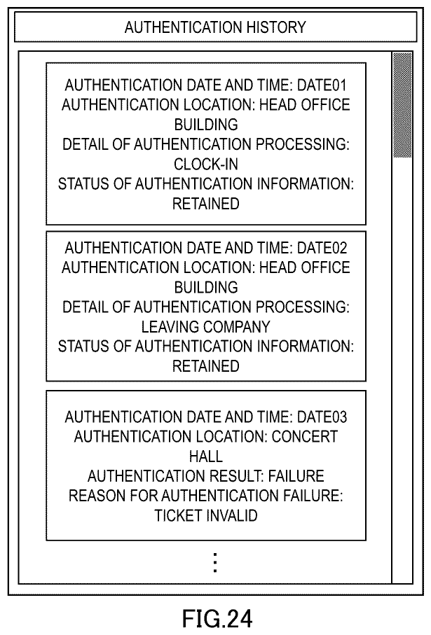

In a case where determination of whether or not provision of a service using business information is possible has failed, the service server 20 (the authentication unit 304) may notify the person to be authenticated (the person to be authenticated specified through the matching processing) of the fact of the failure. In such a case, the authentication unit 304 may also notify the person to be authenticated of a reason for the authentication failure. For example, the authentication unit 304 may notify the person to be authenticated of reasons such as “no permission to enter the office,” “payment by credit card failed,” or “ticket is invalid.” In this case, the authentication unit 304 transmits an authentication failure notification including the system ID of the person to be authenticated and the reason for the authentication failure to the control server 10. The control server 10 identifies the terminal 40 of the person to be authenticated using the system ID and transmits the authentication failure notification to the identified terminal 40. In a case where the authentication failure notification is received, the terminal 40 notifies the user of the reason for the authentication failure. For example, the terminal 40 notifies the user of the reason for the authentication failure by a popup notification such as that shown in FIG. 23. Alternatively, the terminal 40 may generate authentication history using the authentication failure notification. In this case, the terminal 40 may display a cause of the authentication failure, as shown in FIG. 24, in accordance with an operation performed by the user.

In the above example embodiment, the operation of the authentication system has been described by taking a human “face” as an example of biometric information. However, the authentication system disclosed in the present application can also use other types of biometric information. For example, data having individual physical characteristics such as fingerprints, voiceprints, veins, retinas, or patterns of the iris of the eyes may be used. That is, the biometric information of the user may be any information that includes physical characteristics of the user.

The terminal 40 of the user may acquire consent from the user for transmission of original biometric information (for example, a face image) to a service provider each time an original providing request is received from the control server 10. Specifically, in a case where the original providing request is received, the service selection unit 504 of the terminal 40 acquires a permission or refusal related to provision of the original biometric information (for example, a face image) by using a GUI or the like. In a case where consent of the user related to provision of the original biometric information is acquired, the service selection unit 504 transmits the original biometric information stored internally to the control server 10.

In the above example embodiment, a case has been described in which the account management database is configured inside the control server 10, but the database may be constructed in an external database server or the like. That is, some of the functions of the control server 10 may be implemented in another server. More specifically, it is sufficient that the above-described “service selection control unit (service selection control means)” or the like is implemented in any one of the apparatuses included in the system.

A data transmission and reception format among the respective apparatuses (the control server 10, the service server 20, and the authentication terminal 30) is not particularly limited, but data transmitted and received among these apparatuses may be encrypted. Among these apparatuses, biometric information or the like is transmitted and received, and in order to appropriately protect such information, it is desirable that encrypted data be transmitted and received.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to an information processing system or the like that provides a biometric authentication service.

A part or the entirety of the example embodiments described above may be described as in the following supplementary notes, but is not limited to the followings.

### Supplementary Note 1

A terminal, including:
a receiving means that receives, from a service server of a service provider selected by a user from among a plurality of service providers and having succeeded in biometric authentication of the user, an authentication success notification; and
an authentication history control means that performs control related to a history of successful biometric authentication by the service provider, in accordance with reception of the authentication success notification.

### Supplementary Note 2

The terminal according to supplementary note 1, wherein
the authentication success notification includes detailed information of an authentication processing that has been successfully performed by the service provider, and a status of authentication information used for the biometric authentication by the service provider, and
wherein the authentication history control means generates a history related to the biometric authentication of the user by storing the detailed information of the authentication processing and the status of the authentication information.

### Supplementary Note 3

The terminal according to supplementary note 2, wherein
the authentication history control means displays a message including the detailed information of the authentication processing and the status of the authentication information, each time the authentication success notification is received.

### Supplementary Note 4

The terminal according to supplementary note 3, wherein
the authentication history control means displays the history related to the biometric authentication stored, in accordance with a predetermined operation performed by the user.

### Supplementary Note 5

The terminal according to any one of supplementary notes 2 to 4, further comprising:
a storage means that stores original biometric information, which serves as an original source of the authentication information used for the biometric authentication; and
a transmitting means that transmits, in response to a request from a control server performing a management related to the biometric authentication for each of the plurality of service providers, the stored original biometric information to the service server of the service provider selected by the user, via the control server.

### Supplementary Note 6

The terminal according to supplementary note 5, wherein
the original biometric information is a face image, and the authentication information is a feature value generated from the face image.

### Supplementary Note 7

A system, including:
a service server of a service provider selected by a user from among a plurality of service providers and having succeeded in biometric authentication of the user; and
a terminal owned by the user, wherein
the terminal, including:
a receiving means that receives an authentication success notification from the service server; and
an authentication history control means that performs control related to a history of successful biometric authentication by the service provider, in accordance with reception of the authentication success notification.

### Supplementary Note 8

The system according to supplementary note 7, further comprising a control server performing a management related to the biometric authentication for each of the plurality of service providers, and wherein the receiving means receives the authentication success notification via the control server.

### Supplementary Note 9

A control method of a terminal, the control method comprising:
receiving, from a service server of a service provider selected by a user from among a plurality of service providers and having succeeded in biometric authentication of the user, an authentication success notification; and
performing control related to a history of successful biometric authentication by the service provider, in accordance with reception of the authentication success notification.

### Supplementary Note 10

A computer-readable storage medium storing a program causing a computer mounted on a terminal to perform processing for:
receiving, from a service server of a service provider selected by a user from among a plurality of service providers and having succeeded in biometric authentication of the user, an authentication success notification; and
performing control related to a history of successful biometric authentication by the service provider, in accordance with reception of the authentication success notification.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and spirit of the present invention. That is, the present invention of course includes various variations and modifications that could be made by those skilled in the art in accordance with the overall disclosure including the claims and the technical concept.

### Reference Signs List

10 control server
20 service server
30 authentication terminal
40 terminal
100 terminal
101 receiving means
102 authentication history control means
201 communication control unit
202 account management unit
203 business operator management unit
204 service selection control unit
205 user registration control unit
206 storage unit
301 communication control unit
302 business information management unit
303 user registration control unit
304 authentication unit
305 storage unit
311 processor
312 memory
313 input-output interface
314 communication interface
401 communication control unit
402 provided service control unit
403 authentication request unit
404 storage unit
501 communication control unit
502 account generation control unit
503 original information acquisition unit
504 service selection unit
505 authentication history control unit
506 storage unit

What is claimed is:

1. A terminal, comprising:
at least one memory storing a set of instructions; and
at least one processor configured to execute the set of instructions to:
receive, from a service server of a service provider selected by a user from among a plurality of service providers and having succeeded in biometric authentication of the user, an authentication success notification; and
perform control related to a history of successful biometric authentication by the service provider, in accordance with reception of the authentication success notification.

2. The terminal according to claim 1, wherein
the authentication success notification includes detailed information of an authentication processing that has been successfully performed by the service provider, and a status of authentication information used for the biometric authentication by the service provider, and
wherein the at least one processor is further configured to execute the set of instructions to generate a history related to the biometric authentication of the user by storing the detailed information of the authentication processing and the status of the authentication information.

3. The terminal according to claim 2, wherein
the at least one processor is further configured to execute the set of instructions to display a message including the detailed information of the authentication processing and the status of the authentication information, each time the authentication success notification is received.

4. The terminal according to claim 3, wherein
the at least one processor is further configured to execute the set of instructions to: display the history related to the biometric authentication stored, in accordance with a predetermined operation performed by the user.

5. The terminal according to claim 2, wherein
the at least one processor is further configured to execute the set of instructions to:
store original biometric information, which serves as an original source of the authentication information used for the biometric authentication; and
transmit, in response to a request from a control server performing a management related to the biometric authentication for each of the plurality of service providers, the stored original biometric information to the service server of the service provider selected by the user, via the control server.

6. The terminal according to claim 5, wherein
the original biometric information is a face image, and the authentication information is a feature value generated from the face image.

7. A system, comprising:
a service server of a service provider selected by a user from among a plurality of service providers and having succeeded in biometric authentication of the user; and
a terminal owned by the user, wherein
the terminal, comprising:
at least one memory storing a set of instructions; and
at least one processor configured to execute the set of instructions to:
receive an authentication success notification from the service server; and
perform control related to a history of successful biometric authentication by the service provider, in accordance with reception of the authentication success notification.

8. The system according to claim 7, further comprising a control server performing a management related to the biometric authentication for each of the plurality of service providers, and
wherein the at least one processor is further configured to execute the set of instructions to receive the authentication success notification via the control server.

9. A control method of a terminal, the control method comprising:
receiving, from a service server of a service provider selected by a user from among a plurality of service providers and having succeeded in biometric authentication of the user, an authentication success notification; and
performing control related to a history of successful biometric authentication by the service provider, in accordance with reception of the authentication success notification.

10. (canceled)
